(19) United States
(12) Patent Application Publication
(10) Pub. No.: US 2025/0189224 A1
(43) Pub. Date: Jun. 12, 2025

(54) SYSTEM FOR DRYING AN ELECTRODE AND A METHOD OF MANUFACTURING AN ELECTRODE

(71) Applicants: HYUNDAI MOTOR COMPANY, Seoul (KR); KIA CORPORATION, Seoul (KR)

(72) Inventors: Ho Kyeong Oh, Seoul (KR); Se Ho Kwon, Anyang-si (KR)

(73) Assignees: HYUNDAI MOTOR COMPANY, Seoul (KR); KIA CORPORATION, Seoul (KR)

(21) Appl. No.: 18/766,469

(22) Filed: Jul. 8, 2024

(30) Foreign Application Priority Data
Dec. 12, 2023 (KR) 10-2023-0179206

(51) Int. Cl. F26B 13/18; F26B 13/08; F26B 13/12; F26B 23/04; H01M 4/04

(52) U.S. Cl. CPC F26B 13/183; F26B 13/08; F26B 13/12; F26B 23/04; H01M 4/0435; H01M 4/0471

(57) ABSTRACT

A method of manufacturing an electrode for a battery and a system for drying an electrode are disclosed and the system is used to manufacture an electrode. The system for drying an electrode includes a coil disposed along a movement route for an electrode. The electrode includes a base layer made of metal and an electrode active material applied onto the base layer. An electric current may be applied to the coil.

### CROSS-REFERENCE TO RELATED APPLICATION

This application claims under 35 U.S.C. § 119(a) the benefit of and priority to Korean Patent Application No. 10-2023-0179206, filed on Dec. 12, 2023, the entire contents of which are incorporated herein by reference.

### TECHNICAL FIELD

The present disclosure relates to a method of manufacturing an electrode for a battery and a system for drying an electrode, wherein the system is used to manufacture an electrode.

### BACKGROUND

Recently, secondary batteries have been increasingly used for electronic devices, electric vehicles, energy storage devices, and the like. Examples of the secondary batteries, which are widely used, include lithium-ion batteries.

An electrode for the secondary battery may be manufactured by a wet process. Specifically, during the wet process, powder made by mixing an electrode active material, a binder, and a conductive material is prepared, and a slurry is manufactured by mixing the powder with a solvent. Further, a current collector or substrate is coated with the slurry, and then the slurry is dried.

The electrode may be dried by an induction heating device. In this case, because the separate induction heating device is required, the complexity of the facility increases. Also, an excessive amount of electric current is applied because of the absence of an external heating source, which causes frequent oxidation of an electrode tab.

The electrode may also be heated by infrared rays. In a case that the electrode is heated by infrared rays, there is a problem in that an infrared lamp occupies a space in the facility, an electrode movement route having a predetermined length or longer is required, a layout of the facility is difficult to design, and a size of the facility increases.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-mentioned problem. An object of the present disclosure is to provide a system for drying an electrode, which is capable of simplifying a facility required to dry an electrode and minimizing a size of the facility.

The present disclosure has also been made in an effort to provide a system for drying an electrode, wherein the system is capable of shortening a drying time.

The present disclosure has also been made in an effort to provide a system for drying an electrode, wherein the system is capable of preventing an electrode from being overheated or oxidized during a process of drying the electrode.

The present disclosure has also been made in an effort to provide a method of manufacturing an electrode that includes a process of drying an electrode. In particular, the present disclosure has been made in an effort to provide a method of manufacturing an electrode by using the disclosed system for drying an electrode.

The objects of the present disclosure are not limited to the above-mentioned objects. Other objects, which are not mentioned above, may be more clearly understood from the following descriptions by those of ordinary skill in the art to which the present disclosure pertains.

The features of the present disclosure for achieving the above-mentioned objects and carrying out the characteristic function of the present disclosure to be described below are as follows.

In one aspect, the present disclosure provides a system for drying an electrode. The system includes a coil. The coil is disposed along a movement route for an electrode that includes a base layer made of metal and an electrode active material applied onto the base layer. An electric current is applicable to the coil.

In another aspect, the present disclosure provides a method of manufacturing an electrode. The method includes supplying, by an unwinder, an electrode along a movement route and applying a variable electric current to a coil disposed along the movement route.

The present disclosure provides a system for drying an electrode, wherein the system is capable of drying the electrode in the system without a separate induction heating device, thereby simplifying the facility required to dry the electrode and minimizing the size of the facility.

The present disclosure provides a system for drying an electrode, wherein the system is capable of simultaneously drying the outside and inside of the electrode, thereby shortening the drying time.

The present disclosure provides a system for drying an electrode, wherein the system is capable of adjusting the electric current to be applied to an induction coil in conjunction with the traveling speed of the electrode, thereby preventing the electrode from being overheated or oxidized during the process of drying the electrode.

The present disclosure provides a method of manufacturing an electrode. The method includes a process of drying an electrode. In particular, the present disclosure provides a method of manufacturing an electrode, wherein the method uses the system for drying an electrode.

The effects of the present disclosure are not limited to the above-mentioned effects. Other effects, which are not mentioned above, should be more clearly understood by those of ordinary skill in the art from the following description.

Other aspects and embodiments of the disclosure are discussed herein.

It should be understood that the terms “vehicle” or “vehicular” or other similar terms as used herein are inclusive of motor vehicles in general. Such motor vehicles may encompass passenger automobiles including sports utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle that is both gasoline-powered and electric-powered.

The above and other features of the disclosure are discussed herein.

### BRIEF DESCRIPTION OF THE DRAWINGS

The above and other features of the present disclosure are described in detail with reference to certain embodiments thereof illustrated in the accompanying drawings, which are given hereinbelow by way of illustration only. Thus, the drawings are not limitative of the present disclosure, and wherein:

FIG. 1 is a view illustrating a system for drying an electrode according to an embodiment of the present disclosure;

FIG. 2 is a schematic view of a system for drying an electrode according to an embodiment of the present disclosure;

FIG. 3 is a perspective view of a coil of a system for drying an electrode according to an embodiment of the present disclosure;

FIG. 4 is a view illustrating a principle by which a base layer of an electrode is heated by a coil of a system for drying an electrode according to an embodiment of the present disclosure;

FIG. 5 is a view illustrating a relationship between a coil disposed in a roller and an electrode that travels in a system for drying an electrode according to an embodiment of the present disclosure;

FIG. 6 is a perspective view illustrating a direction in which a coil is disposed with respect to an electrode that travels in a system for drying an electrode according to an embodiment of the present disclosure;

FIG. 7 is a front view of the coil and electrode of FIG. 6;

FIG. 8 is a view illustrating a relationship between a heating plate and an electrode that travels in a system for drying an electrode according to an embodiment of the present disclosure;

FIG. 9 is a view illustrating a state in which an electrode active material layer of an electrode is heated and in which the electrode travels in a system for drying an electrode according to an embodiment of the present disclosure;

FIG. 10 is a view illustrating an arrangement relationship between a heating plate and an electrode that travels in a system for drying an electrode according to an embodiment of the present disclosure;

FIG. 11 is a view illustrating moisture and a solvent existing in an electrode before the electrode is dried by a system for drying an electrode according to an embodiment of the present disclosure;

FIG. 12 is a view illustrating a state in which the moisture and solvent, which have remained in the electrode of FIG. 11, are removed after the electrode is dried by a system for drying an electrode according to an embodiment of the present disclosure;

FIG. 13 is a view illustrating a system for drying an electrode that includes an enclosure according to an embodiment of the present disclosure;

FIG. 14 is a view illustrating a system for drying an electrode that includes a cooler according to an embodiment of the present disclosure;

FIG. 15 is a view illustrating a system for drying an electrode that includes a shield member according to an embodiment of the present disclosure;

FIG. 16A is a view illustrating a part of a system for drying an electrode according to an embodiment of the present disclosure in which a coil is disposed outside a roller; and

FIG. 16B is a front view of the part of the system of FIG. 16A.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. While the technical concepts of the disclosure are described in conjunction with various embodiments, it should be understood that the present description is not intended to limit the disclosure to those embodiments. On the contrary, the disclosure is intended to cover not only the disclosed embodiments, but also various alternatives, modifications, equivalents, and other embodiments, which may be included within the spirit and scope of the disclosure as defined by the appended claims.

Specific structural and functional descriptions suggested in embodiments of the present disclosure are exemplified only for the purpose of explaining embodiments according to the concept of the present disclosure. The embodiments according to the concept of the present disclosure may be carried out in various forms. In addition, the present disclosure should not be interpreted as being limited to the embodiments disclosed in the present specification. It should be understood that the present disclosure includes all modifications, equivalents, and alternatives included in the spirit and the technical scope of the present disclosure.

Meanwhile, terms such as “first” and/or “second” in the present disclosure may be used to describe various constituent elements, but these constituent elements should not be limited by these terms. These terms are used only for the purpose of distinguishing one constituent element from other constituent elements. For example, without departing from the scope according to the concept of the present disclosure, a first constituent element may be referred to as a second constituent element, and similarly, a second constituent element may also be referred to as a first constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

Like reference numerals indicate like constituent elements throughout the specification. Meanwhile, the terms used in the present specification are for explaining the embodiments, not for limiting the present disclosure. Unless particularly stated otherwise in the present specification, a singular form also includes a plural form. Terms such as “comprise (include)” and/or “comprising (including)” and variations thereof used in the specification are intended to specify the presence of the mentioned constituent elements, steps, operations, and/or elements. Such terms do not exclude presence or addition of one or more other constituent elements, steps, operations, and/or elements.

Hereinafter, embodiments of the present disclosure are described in detail with reference to the accompanying drawings. When a component, device, element, controller, or the like of the present disclosure is described as having a purpose or performing an operation, function, or the like, the component, device, element, or controller should be considered herein as being “configured to” meet that purpose or perform that operation or function. Terms such as unit, module, device, controller, or the like may refer to one or more units for processing at least one function or operation, and may be implemented by hardware, software, or a combination thereof. The operations of the functions described in connection with the forms disclosed herein may be embodied directly in a hardware or a software module executed by a processor, or in a combination thereof.

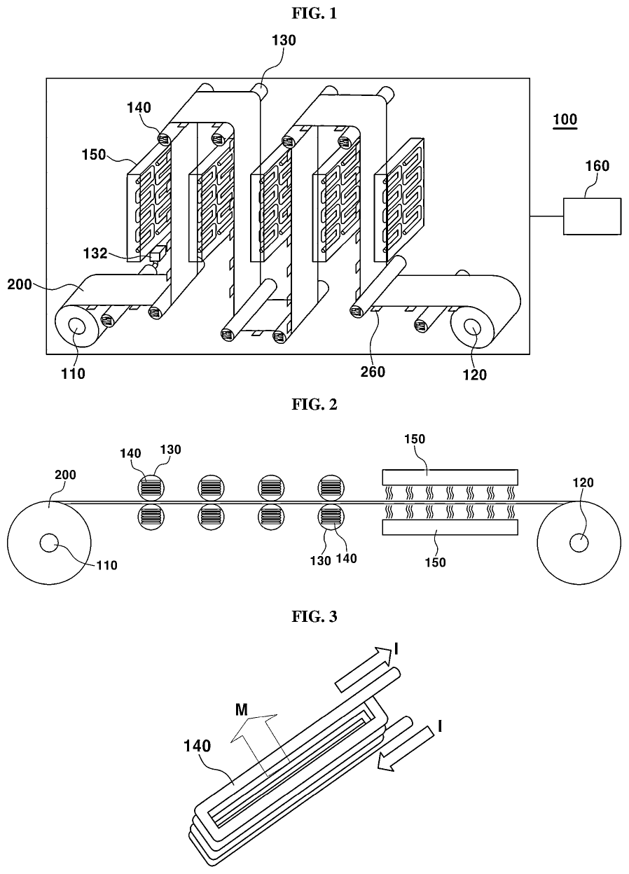

As illustrated in FIGS. 1 and 2, an electrode 200 may be supplied to a system 100 for drying an electrode according to the present disclosure. In an embodiment, the electrode 200 may be supplied by an unwinder 110 around which the electrode 200 is wound in the form of a roll. The electrode 200 may be continuously supplied by rotation of the unwinder 110. The electrode 200, which is dried by the drying system 100, may be wound again in the form of a roll by a winder 120.

The electrode 200 may be an electrode for a secondary battery. For example, the secondary battery may be a lithium-ion battery. The electrode 200 may include an electrode active material 220 and a base layer 240. The electrode active material 220 may further include a binder, a conductive material, and the like. The base layer 240 may be formed of a metal foil, which is made of aluminum, copper, or the like, and is coated with the electrode active material 220. One side or both sides of the base layer 240 may be coated with the electrode active material 220 to manufacture the electrode 200. In an embodiment, the electrode 200 may be a cathode or anode. Electrode tabs 260 for electrically connecting the electrode to external components may be provided on the base layer 240 of the electrode 200.

One or more rollers 130 may be disposed between the unwinder 110 and the winder 120. The rollers 130 may be idler rollers. The rollers 130 may guide the electrode 200 that moves from the unwinder 110 toward the winder 120. For example, the rollers 130 may be disposed at preset positions along a movement route for the electrode 200 and guide the electrode 200.

The drying system 100 may include an edge position control (EPC) device 132. The EPC device 132 may prevent a serpentine motion of the electrode 200 by controlling a position of an end of the electrode 200 that moves in the drying system 100.

According to the present disclosure, the electrode 200 is dried in the drying system 100. Heat may be applied to the electrode 200 and the electrode 200 may be dried by the heat applied to the electrode 200. Specifically, a remaining solvent and moisture, which exist in the electrode 200, may be vaporized and removed by the drying system 100.

The drying system 100 may dry both the inside of the electrode 200, i.e., the base layer 240, and the outside of the base layer 240, i.e., the electrode active material layers 220. To this end, according to an embodiment of the present disclosure, the drying system may include one or more coils 140 and one or more heating plates 150.

In an embodiment, the drying system 100 includes the coil or coils 140. In the embodiment, the coils 140 may be disposed inside respective rollers 130. In another embodiment, the coils 140 may be disposed around the moving electrode 200 without being inserted into rollers 130.

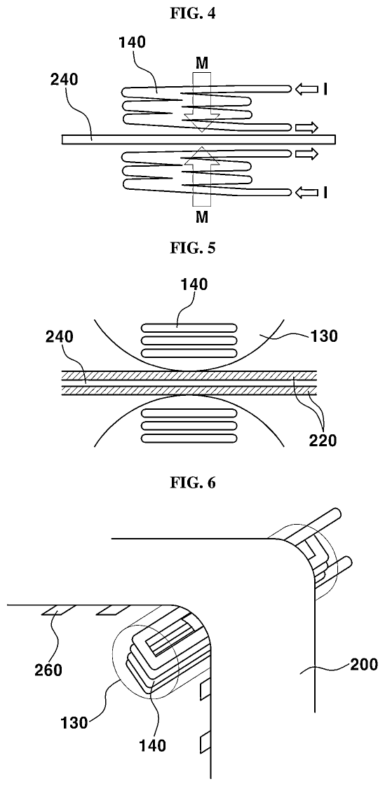

With reference to FIGS. 3 and 4, each coil 140 is configured to receive an electric current I. The base layer 240 of the electrode 200 may be subjected to induction heating by the coil 140 to which the electric current I is applied. A high-frequency alternating current I may be applied to the coil 140 and the coil 140 may form a magnetic field M by the applied electric current I. When the high-frequency alternating current I is applied to the coil 140, the high-frequency magnetic field M is formed by the coil 140 such that an induced current may flow in the base layer 240 of the electrode 200 positioned in the high-frequency magnetic field. Then heat may be generated by electrical resistance existing in the base layer 240. Specifically, joule heating may be generated in the base layer 240 by electric power obtained by multiplying the square of the electric current I by the resistance. Each coil 140 may be similarly formed and utilized.

With reference to FIG. 5, the coil or coils 140 may be disposed in the movement route for the electrode 200 and mounted in the roller or rollers 130. The coils 140 may be inserted into at least some of or all the rollers 130 disposed along the movement route. In an embodiment, the coils 140 may be detachably mounted in the respective rollers 130. Because each roller 130 is detachable, the corresponding coil 140 may be easily maintained, and heating positions may be easily changed. The coil 140 may be fixed at a preset position within the roller 130 and a distance between the coil 140 and the electrode may be constantly maintained. In an embodiment, the rollers 130 may be made of metal or resin-based material having a low-magnetic permeability with low magnetic field shielding properties.

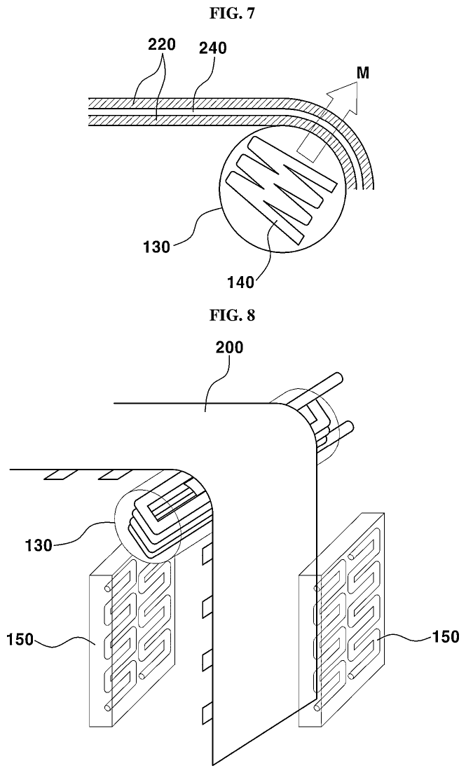

The induced current is generated in the base layer 240 by the magnetic field M generated by the coil or coils 140 in the roller or rollers 130. To this end, as illustrated in FIGS. 6 and 7, a movement direction of the electrode 200 may be perpendicular to a direction of the magnetic field M formed by the coil 140. Heat is generated by the resistance of the base layer 240 made by the induced current flowing in the base layer 240, thereby heating the base layer 240.

As illustrated in FIG. 8, the drying system 100 may include the one or more heating plates 150. The heating plates 150 may be disposed along the movement route of the electrode 200. In a case that the electrode active material 220 is applied onto one side of the base layer 240, one heating plate 150 may be disposed to face the electrode active material 220. In a case that the electrode active materials 220 are applied onto both sides of the base layer 240, the two heating plates 150 may be disposed to face the electrode active material 220 respectively applied onto the surfaces of the base layer 240.

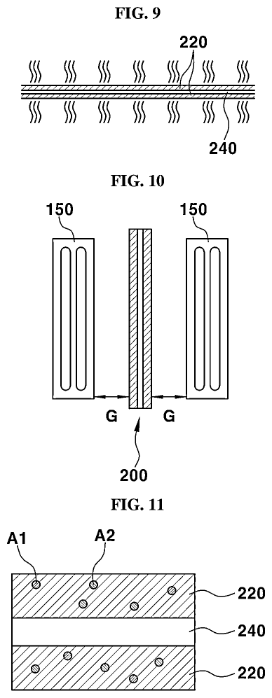

With reference to FIG. 9, the heating plate(s) 150 may heat the electrode active material(s) 220 of the electrode 200. In an embodiment, the heating plates 150 may simultaneously heat the electrode active material 220 applied onto each surface of the base layer 240.

As illustrated in FIG. 10, each heating plate 150 may be disposed to be spaced apart from the electrode 200 at a predetermined gap G. As described below, the heating plate 150 is movably disposed around the electrode 200 such that the gap G may be adjusted. In addition, a distance between the heating plate 150 at a set position and the electrode 200 may be maintained constantly.

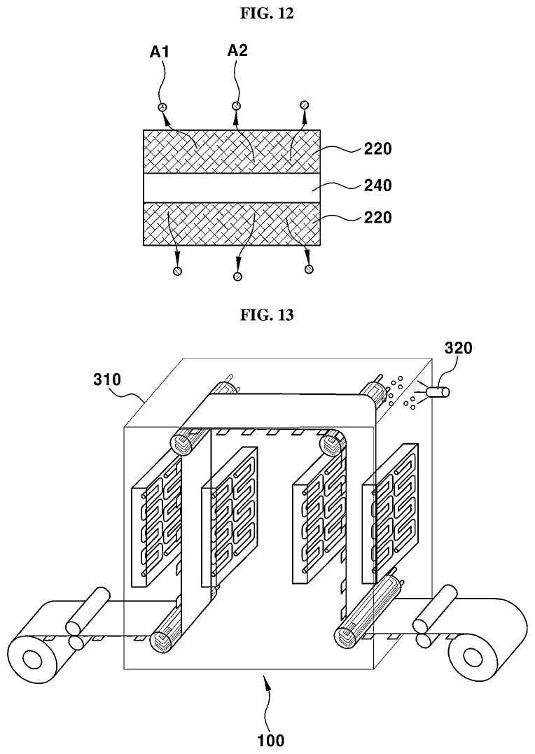

With reference to FIGS. 11 and 12, the electrode active material 220 may be dried as the heating plate(s) 150 is heated. Moisture A1 and a remaining solvent A2, which remain in the electrode active material 220, may be vaporized and removed by the operation of the heating plate(s) 150.

With reference back to FIG. 1, a controller 160 of the drying system 100 is configured to control and supervise the operation of the drying system 100.

The controller 160 may detect a traveling speed of the electrode 200. For example, the controller 160 may receive information on rotational speeds of the winder 120 and/or the unwinder 110. In an embodiment, the drying system 100 may be equipped with a speed sensor configured to detect speeds of the winder 120 and the unwinder 110. The information on the rotational speed detected by the speed sensor may be transferred to the controller 160 and the controller 160 may adjust the rotational speeds of the winder 120 and the unwinder 110. In an embodiment, the drying system 100 may be equipped with a speed sensor configured to detect a traveling speed of the electrode 200 that moves along the movement route. The controller 160 may detect the traveling speed of the electrode 200 based on the traveling speed detected by the speed sensor.

The controller 160 may also control an operation of the coil 140. The controller 160 is electrically connected to the coil 140 and applies the alternating current I to the coil 140. The controller 160 may adjust the electric current I to be applied. In addition, the controller 160 may operate in conjunction with the traveling speed of the electrode 200 and automatically adjust the alternating current to be applied to the coil 140.

In an embodiment, the controller 160 may control the operation of the heating plate(s) 150. A temperature sensor may be disposed around each heating plate 150. An ambient temperature detected by the temperature sensor may be transferred to the controller 160. The controller 160 may adjust the operation of the heating plate(s) 150 based on the received ambient temperature. For example, the controller 160 may adjust heating time, heating frequency, heating intensity, and the like of the heating plate 150.

In some embodiments, the position of the heating plate(s) 150 with respect to the electrode 200, which is traveling, may be adjusted. For example, a drive device may be provided on each or both of the heating plates 150, and the position of the heating plate(s) 150 with respect to the electrode 200 may be adjusted. The drive device may move the heating plate(s) 150 in a direction toward or away from the electrode 200. For example, the drive device may be a linear drive device, such as a ball-screw device. The controller 160 may adjust the position of the heating plate(s) 150 by using the drive device based on a physical condition of the electrode 200, the detected ambient temperature, and the like.

With reference to FIG. 13, according to an embodiment of the present disclosure, the drying system 100 includes an enclosure 310. The enclosure 310 may cover a portion of the movement route for the electrode 200 where the coils 140 and/or the heating plates 150 are positioned. The electrode 200 enters the enclosure 310 before the electrode 200 is heated. The electrode 200 passing through the enclosure 310 may move to the outside of the enclosure 310 and be wound by the winder 120.

The inside of the enclosure 310 may be filled with a gas capable of preventing oxidation. An example of the gas capable of preventing oxidation may be nitrogen. In the enclosure 310 filled with the gas capable of preventing oxidation, the heated electrode tab 260 is prevented from reacting with oxygen and thus from being oxidized. In an embodiment, the enclosure 310 has an injection port 320 through which the gas capable of preventing oxidation may be injected.

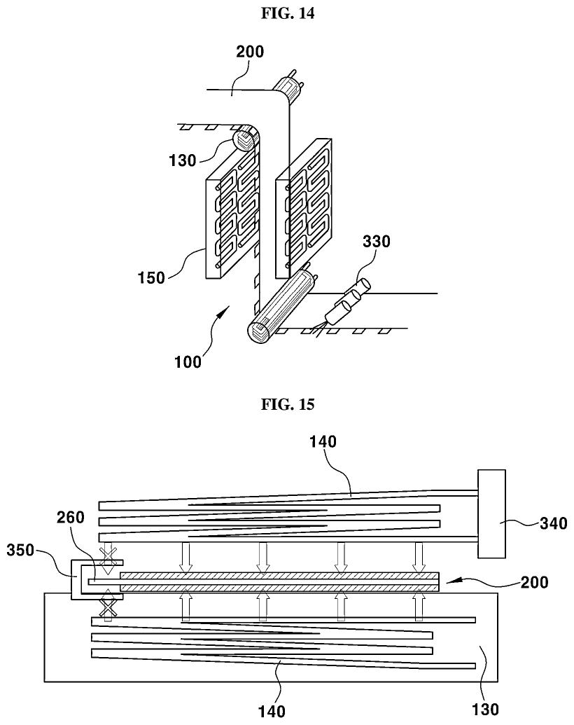

As illustrated in FIG. 14, according to an embodiment of the present disclosure, the drying system 100 includes a cooler 330. After the electrode 200 is heated by the coil or coils 140 or the heating plate(s) 150, the cooler 330 may cool the surface of the heated electrode 200. The cooled electrode 200 may be wound by the winder 120. For example, the cooler 330 may be disposed upstream of the winder 120. The cooler 330 may cool the electrode tab 260 and prevent oxidation of the electrode tab 260. The cooler 330 may remove local residual heat to easily maintain tension of the electrode 200 while the electrode 200 is wound by the winder 120. Additionally, because a temperature of the surface of the electrode 200 is not high immediately after the electrode 200 is wound by the winder 120, the operator may easily handle the electrode 200. The cooler 330 may take various cooling types. For example, the cooler 330 may cool the electrode 200 by using a refrigerant, or an air-cooled or water-cooled cooler 330 may be used.

As illustrated in FIG. 15, according to an embodiment of the present disclosure, the drying system 100 includes a shield member 350. The shield member 350 may be disposed to block the magnetic field M applied to a part of the electrode 200 by the coil or coils 140. For example, the shield member 350 may be disposed to cover a part of the electrode tab 260 in order to block the magnetic field applied to the electrode tab 260. Therefore, the shield member 350 may block the induced current generated on the electrode tab 260 and maintain the electrode tab 260 at a low temperature, thereby preventing oxidation of the electrode 200. The shield member 350 may be made of a ferromagnetic element having high magnetic permeability. For example, the ferromagnetic element may be made of iron, nickel, or the like. The ferromagnetic element material may reduce the density of the peripheral magnetic lines by absorbing the magnetic field.

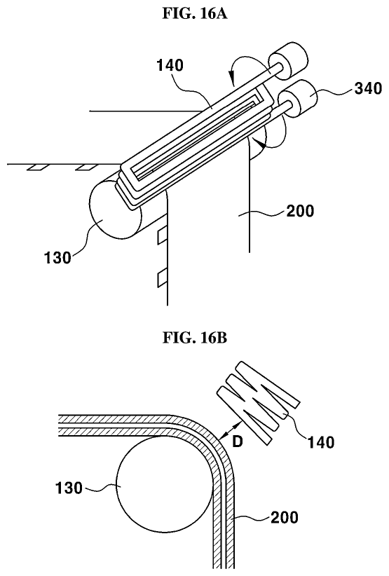

As described above, with reference to FIGS. 16A and 16B, each coil 140 may be disposed around the electrode 200 without being inserted into a roller 130. The coil 140 may be fixed to an external structure by a support structure 340. A distance D between the electrode 200 and the coil 140 may be adjusted by changing the position of the support structure 340. In an embodiment, the support structure 340 may rotatably mount the coil 140. Therefore, an angle of the coil 140 with respect to the electrode 200 may be adjusted.

A process of drying an electrode by using the system 100 for drying an electrode according to the present disclosure is described below with reference back to FIG. 2.

As described above, the drying system 100 may perform a roll-to-roll process. The electrode 200 wound in the form of a roll is unwound by the unwinder 110. A serpentine motion of the electrode 200 is prevented by the EPC device 132. The electrode 200 travels along a predetermined movement route while tension is maintained by a tension adjustment mechanism, such as a dancer roll.

The electrode 200, which travels along the movement route, meets the coil(s) 140 or the coil(s) 140 disposed within the roller(s) 130. The magnetic field, which is generated by the electric current I applied to the coil(s) 140, forms the induced current in the base layer 240 of the electrode 200. Therefore, the base layer 240 may be heated.

The electrode 200, which moves along the movement route, meets the heating plate(s) 150 that is/are an external heating source of the electrode 200. The heating plate(s) 150 may dry the electrode active material 220 by applying heat to the electrode active material 220. Therefore, the moisture and solvent remaining in the electrode 200 may be removed. The electrode 200 which has been dried as described above may be wound by the winder 120.

A method of manufacturing an electrode according to an embodiment of the present disclosure includes a process of drying an electrode. In an embodiment, the drying process may be performed by the drying system 100.

The electrode according to an embodiment of the present disclosure may be manufactured by the manufacturing method. In an embodiment, the drying system 100 may dry the electrode during the process of manufacturing the electrode.

According to an embodiment of the present disclosure, a battery includes the electrode. In an embodiment, the battery may be a secondary battery.

The system for drying an electrode according to the present disclosure may shorten the process time required to dry an electrode and improve the productivity of the electrode. According to the present disclosure, both an inner base layer and an outer active material of the electrode are heated. Thus, the heating efficiency may be improved, the base layer may be quickly heated by induction heating, and the output may be easily adjusted.

According to the present disclosure, because heat is uniformly distributed inside and outside the electrode, it is possible to reduce the occurrence of stress caused by imbalanced thermal expansion. This may provide advantages in terms of maintaining tension and improving quality of the electrode during the process.

According to the system for drying an electrode according to the present disclosure, an induction heating coil may be disposed in an idler roller, thereby reducing the complexity of the facility and easily managing and maintaining the facility.

In addition, according to the system for drying an electrode according to the present disclosure, the heating efficiency may be high, the traveling distance of the electrode may be short, the exposure range of the electrode may be reduced, and the likelihood of the introduction of outside foreign substances may be reduced.

According to the present disclosure, a separate device or chamber for heating the electrode is not required. Thus, the traveling distance of the electrode may be reduced, thereby reducing the size of the facility.

In the related art, an electrode is dried only by an external heat source. Thus, the electrode needs to be exposed to the heat source over a comparatively long period of time to dry the electrode. To this end, the electrode is configured to travel while turning at a large angle, which increases a traveling distance of the electrode. However, because tension applied to the electrode increases as the turning angle increases, the difficulty in managing the facility and the probability of the occurrence of a defect of the electrode are increased. However, according to the present disclosure, because both the inside and outside of the electrode are quickly heated, it is possible to reduce the movement route for the electrode and maintain a small turning angle when the electrode moves in comparison with the related art.

According to the present disclosure, the amount of electric current of the induction coil may be finely adjusted in real time in conjunction with the traveling speed of the electrode. Overheating of the base layer of the electrode and oxidation of the electrode tab are thereby prevented.

Because the system for drying an electrode according to the present disclosure includes the heating plate as an external heat source, along with the induction coil, it is possible to obtain a satisfactory drying effect even though the amount of electric current of the induction coil is not excessive and while also preventing oxidation of the electrode tab.

The technical concept of the present disclosure, which has been described above, is not limited by the aforementioned embodiment and the accompanying drawings. It should be apparent to those of ordinary skill in the art to which the present disclosure pertains that various substitutions, modifications, and alterations may be made without departing from the technical spirit of the present disclosure.

The technical concepts of the disclosure have been described in detail with reference to various embodiments thereof. However, it will be appreciated by those of ordinary skill in the art that changes may be made in these embodiments without departing from the principles and spirit of the disclosure, the scope of which is defined in the appended claims and their equivalents.

What is claimed is:

1. A system for drying an electrode, the system comprising:
a coil disposed along a movement route of an electrode,
wherein the electrode includes a base layer made of metal and an electrode active material applied onto the base layer, and
wherein an electric current is applicable to the coil.

2. The system of claim 1, wherein the coil is fixed to a support structure and configured to be rotatable.

3. The system of claim 1, wherein the coil is disposed within a roller disposed in the movement route for the electrode.

4. The system of claim 3, wherein the roller is an idler roller configured to guide the electrode that moves along the movement route.

5. The system of claim 3, wherein the coil is disposed within the roller and is detachable from the roller.

6. The system of claim 1, wherein the coil is disposed to generate a magnetic field in a direction perpendicular to a movement direction of the electrode.

7. The system of claim 1, wherein an edge position control (EPC) device configured to prevent a serpentine motion of the electrode is disposed in the movement route.

8. The system of claim 1, further comprising:
a heating plate disposed along the movement route of the electrode.

9. The system of claim 8, wherein a position of the heating plate with respect to the electrode is adjustable.

10. The system of claim 8, further comprising:
an unwinder configured to allow the electrode to be wound in a form of a roll to move along the movement route; and
a winder configured to wind the electrode that has passed the coil and the heating plate in the form of the roll.

11. The system of claim 8, further comprising:
a controller configured to control an operation of the coil and an operation of the heating plate.

12. The system of claim 11, wherein the controller is configured to detect a traveling speed of the electrode and adjust the electric current based on the detected traveling speed.

13. The system of claim 11, wherein the controller is configured to detect a temperature around the movement route and configured to control operation of the heating plate based on the detected temperature.

14. The system of claim 8, further comprising:
an enclosure configured to cover a region in which the coil and the heating plate are positioned,
wherein an inside of the enclosure is filled with a gas capable of preventing oxidation.

15. The system of claim 8, further comprising:
a cooler configured to cool the electrode passing the coil and the heating plate.

16. The system of claim 1, wherein a shield member is disposed at a position in the movement route at which the electrode meets the coil, and wherein the shield member is configured to block a magnetic field generated by the coil with respect to a part of the electrode.

17. A method of manufacturing an electrode, the method comprising:
supplying, by an unwinder, an electrode along a movement route; and
drying the electrode by applying a variable electric current to a coil disposed along the movement route.

18. The method of claim 17, further comprising:
operating a heating plate disposed along the movement route.

19. The method of claim 18, further comprising:
winding, by a winder, the electrode that has passed the coil and the heating plate in a form of a roll.

20. The method of claim 19, further comprising:
cooling, by a cooler, the electrode before winding the electrode.
